(19) United States
(12) Patent Application Publication
(10) Pub. No.: US 2004/0049980 A1
(43) Pub. Date: Mar. 18, 2004

(54) Cohesive polymer plug for use in plant production

(76) Inventors: Laura Principe, Vancouver (CA); Kelvin S. Chiddick, North Vancouver (CA)

Correspondence Address: Gerald O.S. Oyen, Oyen Wiggs Green & Mutala, #480, 601 West Cordova Street, Vancouver, BC, V6B 1G1, CA

(21) Appl. No.: 10/244,459

(22) Filed: Sep. 17, 2002

(51) Int. Cl. A01G 31/00

(52) U.S. Cl. 47/64; 264/109

(57) ABSTRACT

A process for producing hydrophilic growing media, preferably soil plugs, having improved properties and minimal plant toxicity. The method involves forming a resilient, integral, dimensionally stable, cohesive, homogenous mass by contacting an aggregate with a hydrophilic urethane prepolymer, glycol, plasticizer and water. The glycol acts as a coalescing agent between the prepolymer, plasticizer and water and enables flexible open cell soil plugs to be produced over a wide range of mixes. Upon curing, the prepolymer binds the aggregate material together. The mixing of the aggregate, prepolymer, glycol and water is conducted under conditions which entrain air in the media and do not adversely affect the growth of seedlings or plants.

### FIELD OF THE INVENTION

The present invention relates to stable soil plug which contains polymer and growing media for the germination of seeds and the growing or propagation of plants, and a method of manufacturing such soil plugs.

### BACKGROUND OF THE INVENTION

Modern seed germination nurseries use assembly line methods in planting seeds in small nutrient soil media plugs which are arranged in a grid-like pattern on trays. Once the seeds germinate and the seedlings grow, their root systems require larger soil plugs so the initial small soil plugs are machinery withdrawn from the trays in rapid order and automatically transplanted to trays with larger soil plugs. A problem with this type of assembly line operation is that in the transplanting process, some of the soil from the small soil plugs drops off and the seedlings suffer “transplant shock”, which retards their growth and delays production. In some cases, the seedlings or plants die.

A number of approaches have been used over the years in stabilizing the soil plugs to prevent plug breakup, such as:

(1) Preparation of soil plugs using varying levels of urethane binders.

(2) Soil stabilization using various additives such as polystyrene-buta-diene emulsion, adhesive coated fibres or lignosulfonate binders.

(3) Artificial soils, such as polymer-fibre based soils, mineral wool bound by acrylic acid copolymers, open-cell polymer foams (various polymers and additives), or hydrophilic gels (polyurethane cross-linked acrylic acid).

In modern plant germination and seedling nurseries, seedling soils, potting soils, and the like, are mixed by a soil company and delivered to the plant nursery growers. The growers fill trays containing a plurality of seedling pockets or cells with the appropriate soil, normally using an automated filler, and then plant the seeds in the soil in the pockets. The trays are placed in greenhouses and watered on a regular basis. In the case of cuttings, the growers plant the cuttings into the soil in the cells and then water them on a regular basis. Propagation normally takes between ten to twenty-one days.

Plant seedlings or shoots can be planted and grown in rooting media comprising soil mixture and a synthetic binder, such as an organic resin polymer. Such rooting media or grow plugs in trays eliminates the need to use pots, which add substantial weight and cost to transportation of plants. U.S. Pat. No. 3,805,531 discloses a typical rooting media formed by mixing a prepolymer with aggregate or soil mixture and adding water to the mixture. Upon curing of the prepolymer, a cohesive mass is formed.

Similarly, U.S. Pat. No. 4,175,355 discloses soil plugs that use a mixture of soil material comprising at least 15% polyurethane by weight on a dry basis of the soil material. In the disclosed method, a slurry is prepared by intensively mixing the polyurethane prepolymer, soil material and water. The slurry is then cast into a mold and after at least partial hardening of the polyurethane resin forming material, the resulting plug is removed from the mold.

A disadvantage of a polyurethane plug is that while it holds the soil material together, the relatively high percentage of polyurethane in the plugs impedes growing of the seedling. As a general rule, therefore, the less synthetic material there is in such plugs, the better the seedlings grow. The problem to be overcome is to discover a soil material binder that does not retard plant growth.

While the reasons for retarded plant growth are not known, the presence of the synthetic material is believed to impair access of water and air to the plant roots. Ideally, therefore, grow plugs would contain as little synthetic material as possible. However, conversely, the synthetic material is an important component of such plugs in order to provide a self-supporting, stable plug that does not disintegrate upon handling in a commercial operation. U.S. Pat. No. 4,175,355 expressly teaches that using less than about 15% polyurethane resin by weight on a dry basis results in the rooting media crumbling and falling apart.

U.S. Pat. No. 5,209,014 discloses molds for growing seedlings. The molds are formed of turf, water, nutrients and a synthetic molding materials such as a polyurethane resin. The turf mixture is first ground and the prepolymer is added in the amount of about 6 to 8% by weight to the turf mixture. The term “dry mass” is evidently used to indicate a turf mixture to which additional water has not been added. The turf mixture will inherently contain moisture, but the “dry mass” referred to would not include the water that was introduced to the turf mixture prior to the addition of the prepolymer.

U.S. Pat. No. 3,373,009, Pruitt et al., discloses an integral nutrient plant growth medium consisting essentially of a stable, water-insoluble, open-celled foamed polymer matrix which has plant nutrients in a leach resistant nutrient mixture imbedded therein. The leach resistant nutrient mixture contains from about 2 to 60 parts by weight of a substantially insoluble salt mixture selected from the group consisting of substantially water-insoluble inorganic salts, fritted salts and resin imbedded inorganic salts and from about 0.3 to 7.8 parts by weight of nitrogen calculated as elemental nitrogen. The nitrogen is supplied at least in part as nitrate exchanged on an anion exchange resin. The leach resistant nutrient mixture is added in an amount which does not exceed about 65% of the weight of the polymer mixture prior to foaming.

U.S. Pat. No. 3,812,619, Wood et al., discloses horticultural foam structures prepared by reacting an isocyanate capped polyoxyethylene polyol reactant with large amounts of an aqueous reactant containing seeds. Desirably, the aqueous reactant further includes materials useful or necessary for plant growth. The resultant foam structures provide an effective means for protecting dormant seeds as well as means for sustaining seed germination and plant growth.

U.S. Pat. No. 4,034,508, Dedolph, discloses a polymerized soil plug with a growing plant molded therein. The plug comprises a body of spongy open-celled hydrophilic polymer and a growing plant which has its roots in the body of spongy polymer. The stalk of the plant extends outwardly from one surface. A quantity of particles of soil mix is distributed throughout the body of spongy polymer. A quantity of synthetic organic plastic resin is reacted in situ to form the body spongy open-celled hydrophilic polymer which binds the particles of soil mix therein and in the form of a plug. The soil mix comprises from about 20% to about 80% by dry weight of the soil plug. The roots are distributed substantially uniformly throughout the adjacent portions of the plug and the stalk is intimately surrounded by the plug. The method of making such a soil plug is also disclosed, as well as a package for retail sale of the soil plugs with growing plants therein. The patent also discloses hangers and a plaque for receiving the soil plugs.

U.S. Pat. No. 4,175,355, Dedolph, discloses a rooting media in the form of a resilient, integral body of spongy open-celled hydrophilic polymer forming a first essentially continuous phase extending throughout the body and having passages therethrough forming a second essentially continuous phase extending throughout the body. A quantity of particles of soil mixture are distributed throughout the body of spongy polymer and held thereby with a substantial portion of the surface area of the particles of soil mixture exposed and in communication with the passages. The exposed particles of soil mixture provide colloidal contact exchange surfaces in communication with the passages and have collectively a porosity maintenance capacity and a water holding capacity and an ion exchange capacity and a pH buffering capacity. Also disclosed is a method of making such a body of rooting media, as well as a release agent useful in that method. Further, a particular form of rooting media for use in propagation by air layering and a method of propagation by air layering are disclosed.

U.S. Pat. No. 4,213,273, Dedolph, discloses a field transplant system including a machine for sequentially forming groups of polymerized soil plugs having seed receiving recesses in one end thereof and supported on a carrier. In certain cases, the carriers are interconnected by strips, the carrier being used to transport the soil plugs through a seeding station and then to a germination station and then ultimately to a growing station either in a flat or on a plant turning machine in a greenhouse. Seeds are germinated and grown to transplant size, and then using the carrier, the soil plugs with the transplants growing therein are transported to the field for transplanting by an automatic transplanter. Several forms of soil plugs are disclosed, and several methods for supplying seeds to the soil plugs are disclosed, as well as an improved method of mounting a mat of soil plugs on the cylinder of a plant turning machine.

U.S. Pat. No. 4,495,310, Dedolph, discloses a method of forming a urethane prepolymer comprising the steps of gradually adding an isocyanate compound to a hydrophilic polyether or polyester compound without substantial added mixing. This yields a relatively dense isocyanate layer. A polyether or polyester layer overlying the isocyanate layer is formed. The urethane prepolymer-forming reaction occurs at the interface between the layers. The resulting urethane prepolymer may be reacted with water to form a cellular urethane polymer, or with an aqueous slurry of unconsolidated aggregate material to form a consolidated aggregate product, such as a plant growth supporting rooting medium.

U.S. Pat. No. 5,209,014, Teichmann, discloses a mold for retaining a seedling during handling and transportation, whereby the mold is formed of turf, water, nutrients and a synthetic molding material. The retaining mold form receives a seedling and is then packaged as needed for further handling prior to being planted and watered. The seedling grows directly in the mold. The invention also includes a process and device for manufacturing such molds.

U.S. Pat. No. 5,588,783, Brabston et al., discloses a reinforcement of soil to prevent erosion or strength loss, for example in berms and embankments. The reinforcement involves the addition of fibers having an adhesive coating to the soil. Both natural and synthetic fibers may be used. Degradable or non-degradable adhesives may be employed with a preferred adhesive being one which is moderately soluble in water.

U.S. Pat. No. 5,791,085, Szmidt et al., discloses a porous solid material for plant propagation which includes granules of a porous expanded mineral, such as perlite or vermiculite, distributed within a porous, open-cell foamed hydrophilic water-retentive polyurethane matrix. The material may be molded into sheets of break-off units for seed germination and propagation.

EPO 0 313 255 A1, Exxon Chemical Patents Inc., discloses a plant growth medium for promoting growth of seeds, seedlings, or roots which is formed from a solid porous medium comprising an open cell foamed homo- or co-polymer of monomers selected from olefins, unsaturated monocarboxylic acid esters and unsaturated monocarboxylic acids (or ionomer derivatives).

WO 96/25031, Preforma Westland B. V., discloses a process for producing hydrophilic growing media, preferably plugs. The growing media has improved properties and a minimal amount of binding agent. The method forms a resilient, integral, dimensionally stable, cohesive, homogenous mass by contacting an aggregate with a hydrophilic urethane prepolymer and water. Upon curing, the prepolymer binds the aggregate material together. The mixing of the aggregate, prepolymer and water is conducted under specific, carefully controlled conditions, which enables the use of less prepolymer than would otherwise be necessary to obtain a given strength and stable air space.

### SUMMARY OF THE INVENTION

The subject invention pertains to a process for producing hydrophilic plant growing media which possesses improved properties over conventional growing media. The method forms a resilient, integral, dimensionally stable, cohesive, homogeneous mass by contacting an aggregate with a hydrophilic urethane prepolymer, a glycol, a plasticizer and water. Upon curing, the prepolymer binds the aggregate material together. The mixing of the aggregate, prepolymer, glycol, plasticizer and water is conducted under specific, carefully controlled conditions to provide a plant growing media with incorporated stable air space. The glycol acts as a coalescing agent between the polymer, the plasticizer and the water to facilitate obtaining a homogeneous product.

The invention is directed to a process of preparing a growing media. The process includes forming a slurry of aggregate, hydrophilic polyurethane prepolymer, glycol, plasticizer and water, mixing the slurry at a temperature which enables the rate of polymerization of the prepolymer to be controlled, and for a time sufficient to create a homogeneous mix, pouring the mix into a receptacle and allowing the resulting mix to polymerize.

The mixing can be performed at a low shear rate to preserve the particle size of the aggregate. The slurry can have a temperature below about 20° C.

The aggregate can be peat, coir (coconut husk), perlite, vermiculite, pumice, bentonite, methocel, wood pulp, bark or sawdust, or mixtures thereof. The prepolymer and aggregate can be present in a ratio of 0.4-0.06. The glycol can be ethylene glycol, diethylene glycol or triethylene glycol.

The invention is also directed to a process of preparing a cohesive, stable, self-supporting, open celled growing media. The process includes forming a slurry comprising an aggregate having a specified particle size distribution, a hydrophilic polyurethane prepolymer, a glycol, a plasticizer and water, mixing the slurry at a temperature below about 20° C., said mixing being conducted with a sufficiently low shear that the particle size distribution of the aggregate is not materially altered, and for a time sufficient to create a homogeneous air entrained mix, pouring the mix into a growing medium receptacle and allowing the resulting mix to harden and polymerize.

The invention also pertains to a method for preparing cohesive, stable, self-supporting, open celled growing media, comprising: (a) combining aggregate, hydrophilic polyurethane prepolymer, glycol, plasticizer and water to form a mixture at a temperature sufficiently low to allow time for the mixing set forth in step (b) below to be performed without curing the prepolymer; (b) mixing the mixture at said temperature, said mixing being conducted with a shear sufficiently low that the particle size distribution of said aggregate is not materially altered, and for a time sufficient to create a homogeneous mix; (c) filling a mold with the homogeneous mix; and (d) allowing the resulting mix to foam and cure in the mold.

The invention also pertains to a stable, self-supporting, open celled plant growing media formed from an aggregate bound by polymerized hydrophilic polyurethane polymer, plasticizer and glycol, uniformly distributed therein. The invention can also include one or more of the following: fertilizer, amendments, micronutrients (S, B, Cu, Fe, Mn, Mo and Zn), dolomite, limestone, gypsum, monopotassium phosphate, single super phospate, calcium nitrate, potassium nitrate and/or wetting agent.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention pertains to formulations for producing a cohesive polymerized soil plug, that can be transplanted from small tray cells into larger tray cells or pots, manually or by machine, without losing a significant amount of the growing medium from around the roots of the seedlings and thus preventing transplant shock. The formulations also improve growth rates so plant production time is shortened.

An important aspect of the subject invention is the incorporation in the growth mixture, when it is being prepared for polymerization, of a glycol (ethylene glycol, diethylene glycol or triethylene glycol). The formulations also incorporate one of the following plasticizers: tricryselphosphate, dioctylphthalate or diisooctylphthalate. The inventors have discovered unexpectedly that the presence of a glycol in the growth media is not only helpful in coalescing the polymer, plasticizer and water to facilitate the production of a homogeneous mixture but also, once the prepolymer has fully reacted, the plasticizer and the glycol contribute to the flexibility of the plug, which is an advantage. The incorporation of the glycol with the other components enables flexibility and plug strength to be controlled over a large range of cell sizes, but it also is not toxic to seedlings and plants. The glycol also serves as a safety feature by reacting with any unreacted isocyanate, which is toxic to plants.

Suitable aggregates that can be used in the present invention include peat moss, coir (coconut husk), perlite, vermiculite, pumice, wood pulp, bark, sawdust, and mixtures thereof. Of these, peat is the preferred aggregate.

It is well known that the moisture content of commercially available peat moss varies. The peat should have a moisture content which permits ready handling, but the moisture content of the peat should not be so high that excess water interferes with the polymerization of the polymer reactants in the soil plug.

Suitable binding agents for the plugs of the present invention include hydrophilic polyurethane prepolymers and resins, such as those that are the reaction product of a polyol, preferably a polyoxyethylene polyol, with a polyisocyanate. One suitable family of aromatic isocyanate prepolymers is available from International Polyurethane Systems, Inc., P.O. Box 3309, Salmon Arm, British Columbia, Canada, under the product name IPSD 1010/2 Isocyanate (diphenylmethane diisocyanate (MDI) prepolymer). The glycol (ethylene glycol, diethylene glycol or triethylene glycol) is readily available in the marketplace from a number of sources such as Union Carbide and Dow Chemical, or their distributors.

A mixer is preferably used to mix the various components into a slurry which ultimately cures in the tray receptacles or molds to form the grow plugs. The slurry includes the aggregate, the hydrophilic polyurethane prepolymer binding agent, glycol plasticizer and water. These are preferably supplied to the mixer separately. Although the order of addition of the ingredients is not critical, preferably the aggregate is added to the mixer first, followed by the addition of water, the glycol, plasticizer and the polymer.

It is important to the success and control of the subject invention to produce successful flexible soil plugs that the temperature of the slurry during mixing, and the temperature of the slurry during curing be kept reasonably low to ensure that the polymerization reaction proceeds slowly while the soil plugs are being formed. This results in a desirable stable cohesive product which has a suitable pore size distribution for a balance of water retention and aeration leading to good root growth. More specifically, by ensuring a slow prepolymer cure rate, a homogeneous mix can be achieved. This is true even if the mixing is conducted under low shear so as not to damage the aggregate particles. Sufficient air from mixing and carbon dioxide from blowing (resulting from the reaction between the prepolymer and water) become entrained to provide a low density product. This results in a light homogeneous mix which can be readily emptied into molds. The temperature of the slurry can be readily controlled by controlling the temperature of the water that is added to the aggregate and the binding agent. Thus, the temperature of the glycol, plasticizer and the prepolymer can be relatively high, or at least at room temperature, but the addition of suitably cold water to the prepolymer and aggregate will result in a slurry which has the desired temperature as long as the water temperature is properly regulated. Since the amount of water greatly exceeds the amount of prepolymer and glycol, the initial temperature of the prepolymer has virtually no effect on the temperature of the slurry.

The mixer should produce a homogeneous mix during a mixing time that is sufficiently long to allow sufficient air to become entrained in the mix. But at the same time, it should be short enough so that the binding agent does not cure in an amount sufficient to prevent filling of the receptacles of the trays, or in amount sufficient to cause the growth media to break into clumps, thereby weakening the product. Whether or not a particle mixer is capable of forming a homogeneous mix can be determined visually. In non-homogeneous mixes, large particles of cured polymer are readily visible, and/or the resulting media is relatively weaker than otherwise identical media prepared from homogeneous mixes.

Since the temperature of the mix is sufficiently low to inhibit substantial curing of the prepolymer, the prepolymer has an opportunity during the mixing period to infuse into the interstices amongst the aggregate fibers in an amount sufficient to form a homogeneous composition which, upon foaming and curing, is strong, cohesive, flexible, stable and self-supporting. With the lowered temperature of the mix, relatively long mixing times under low shear can be done to achieve a homogeneous mix without the prepolymer curing to the point that it inhibits mixing or the filling of the mix into suitable molds or trays.

The following method is exemplary and not limiting. The subject invention can be practiced by a batch mixing operation coupled with a continuous fill operation. The various components making up the growing media can be metered into a mixing chamber on a batch basis, mixed, and then poured into a tray filling machine. While in the tray filling machine, the mix is preferably slowly tumbled or agitated, and is continuously forced out openings in the bottom of the tray filling machine into the receptacles of suitable trays or molds properly spaced and aligned on a conveyor belt. The speed of the conveyor belt should be regulated so that the filling operation is continuous. The speed can be based upon the predetermined mixing time in the mixer, so that there is always some mixed growing media composition in the tray filling machine during the operation. The amount of product emptying into each tray is controlled and is usually in quantities raging from 1 to 5 g per cell. A lid having spikes is placed on top of the tray in order to create holes or “dibbles” for the seed or cutting to be placed into.

Those skilled in the art will recognize that other conventional additives can be included in the growing media, such as nutrients, wetting agents, fertilizers, fungicides and pesticides. Preferably such additives are added during the batch mixing stage. If water soluble, these additives can be pre-dissolved in water.

An important feature of the subject invention is the incorporation of a glycol into the mix formulation. The inventors have discovered that the presence of a glycol (ethylene glycol, diethylene glycol or triethylene glycol) in predetermined quantities in the soil plug recipe acts as a coalescing agent between the prepolymer, water and the plasticizer and enables the operator to obtain a homogeneous mixture and to control plug strength and flexibility over a large range of cell sizes. The inventors have not discovered phytotoxicity in any of the plants trialed to date: Coleus, Passion Flower, Sunny Orange Wonder, Mona Lavender, Goodenia, Lamium Beacon Silver, Cuphia Firecracker, Perilla Magilla and White Plumbago. Another advantage to using a glycol in the formulation is that the operator is able to control the flexibility of the plug and therefore eliminate root damage caused by excessive flexibility when the plug is removed from the cell.

Two preferred formulations have been developed:

| | A | B |
|---|---|---|
| Peat | 60 g (15% based | 80 g (20% based |
| | on polymer) | on polymer) |
| Water | 120 g | 120 g |
| Diethylene glycol | 15 g | 15 g |
| Hydrophilic polyurethane | 400 g | 400 g |
| prepolymer binder | | |
| Dioctyl plthalate | 135 g | 135 g |
| plasticizer | | |
| Plant nutrients | Suitable amount | Suitable amount |
| Dolomite limestone | Suitable amount | Suitable amount |

Peat content can vary from 5% to about 50% based on the amount of polymer. The peat, water, glycol and plasticizer are premixed, and then the prepolymer binder is added. The mixture is stirred with a mixer for 40 seconds to disperse the peat. The mixture is then filled into the cells of a conventional seed tray or mold (which has been sprayed with a release agent), and allowed to foam until fully cured. The resulting product is a lightweight cohesive open cell foam/peat charged growth plug ready for a seed or a cutting to be grown in the foam.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A process of preparing a growing media comprising forming a slurry of aggregate, hydrophilic polyurethane prepolymer, glycol, plasticizer and water, mixing the slurry at a temperature which enables the rate of polymerization of the prepolymer to be controlled, and for a time sufficient to create a homogeneous mix, filling the mix into a receptacle and allowing the resulting mix to polymerize.

2. A process as claimed in claim 1 wherein the slurry has a temperature below about 20° C.

3. A process as claimed in claim 1 wherein the aggregate is peat, coir (coconut husk), perlite, vermiculite, pumice, wood pulp, bark or sawdust, or mixtures thereof.

4. A process as claimed in claim 1 wherein the aggregate is peat.

5. A process as claimed in claim 1 wherein the prepolymer and aggregate are present in a ratio of 0.4-0.06.

6. A process as claimed in claim 1 wherein the glycol is ethylene glycol, diethylene glycol or triethylene glycol.

7. A process as claimed in claim 1 wherein the plasticizer is tricrysel phosphate, dioctylphthalate or diisooctylphthalate.

8. A process of preparing a cohesive, stable, self-supporting, open celled growing media, comprising forming a slurry comprising an aggregate, a hydrophilic polyurethane prepolymer, a glycol, a plasticizer and water, mixing the slurry at a temperature below about 20° C. for a time sufficient to create a homogeneous air entrained mix, pouring the mix into a growing medium receptacle and allowing the resulting mix to foam and cure.

9. A process as claimed in claim 8 wherein the aggregate is peat, coir (coconut husk), perlite, vermiculite, pumice, bark or sawdust, or mixtures thereof.

10. A process as claimed in claim 8 wherein said aggregate is peat.

11. A process as claimed in claim 8 wherein the glycol is ethylene glycol, diethylene glycol or triethylene glycol.

12. A process as claimed in claim 8 wherein the plasticizer is tricrysel phosphate, dioctylphthalate or diisooctylphthalate.

13. A method for preparing cohesive, stable, self-supporting, open celled growing media, comprising:
(a) combining aggregate, hydrophilic polyurethane prepolymer, glycol, plasticizer and water to form a mixture at a temperature sufficiently low to allow time for the mixing set forth in step (b) below to be performed without prematurely curing the prepolymer;
(b) mixing the mixture at said temperature for a time sufficient to create a homogeneous mix;
(c) filling a mold with the homogeneous mix; and
(d) allowing the resulting mix to foam and cure in the mold.

14. The method of claim 13, wherein said aggregate is peat, coir (coconut husk), perlite, vermiculite, pumice, bark or sawdust, or mixtures thereof.

15. The method of claim 13, wherein the aggregate is peat.

16. A stable, self-supporting, open celled plant growing media formed from an aggregate bound by polymerized hydrophilic polyurethane polymer, plasticizer and glycol, uniformly distributed therein.

17. The growing media of claim 16, wherein the aggregate is peat, soil, coir (coconut husk), perlite, vermiculite, pumice, bark or sawdust, or mixtures thereof.

18. The growing media of claim 16 wherein the aggregate is peat.

19. The growing media of claim 16 wherein the glycol is ethylene glycol, diethylene glycol or triethylene glycol.

20. The growing media of claim 18 wherein the glycol is ethylene glycol, diethylene glycol or triethylene glycol.

21. The growing medium of claim 16 wherein the plasticizer is tricrysel phosphate, dioctylphthalate or diisooctylphthalate.
